(19) United States
(12) Patent Application Publication
(10) Pub. No.: US 2026/0319081 A1
(43) Pub. Date: Oct. 15, 2026

(54) Method and Device for Processing Raw Data of a UWB Sensor

(71) Applicant: Bayerische Motoren Werke Aktiengesellschaft, Muenchen (DE)

(72) Inventor: Marjan Buzanin, Muenchen (DE)

(21) Appl. No.: 19/484,506

(22) PCT Filed: Jan. 31, 2024
(86) PCT No.: PCT/EP2024/052302

§ 371 Date: Nov. 14, 2025

(30) Foreign Application Priority Data
Jun. 21, 2023 (DE) 10 2023 116 234.9

(51) Int. Cl. G01S 13/02; G01S 7/292; G01S 13/18

(52) U.S. Cl. CPC G01S 13/0209; G01S 7/292; G01S 13/18

(57) ABSTRACT

The disclosure relates to a method for processing raw data of a UWB sensor which is arranged under the roof lining of an interior of a motor vehicle for monitoring the vehicle interior. The raw data comprise a plurality of radar echoes of a radar pulse sent repeatedly during a specified time interval as a function of a number of taps representing a characteristic value for the range of the UWB sensor. After filtering, the plurality of radar echoes are transferred to a computing unit in order to be stored together in the computing unit as a radar image for further processing. The number of taps is varied depending on an evaluation of a portion of the radar echoes.

### CROSS-REFERENCE TO RELATED APPLICATIONS

The present application is the U.S. national phase of PCT Application PCT/EP2024/052302 filed on Jan. 31, 2024, which claims priority of German patent application No. 10 2023 116 234.9 filed on Jun. 21, 2023, the entire contents of which are incorporated by reference herein.

### FIELD

The disclosure relates to the field of vehicles and is directed to a method and device for processing raw data of a UWB sensor (UWB=ultra-wideband) which is arranged in a vehicle interior under the roof lining of a motor vehicle for monitoring the interior. Such a UWB sensor is used for occupant detection in the motor vehicle.

### BACKGROUND

The principle of a UWB sensor, which is a radar sensor, is to emit radar pulses and then receive radar echoes reflected by objects. As a rule, a plurality of radar pulses are emitted within a specified time interval, which are then received as radar echoes. The duration of a single radar pulse is usually in the order of a few nanoseconds to a few 100 picoseconds. Through appropriate evaluation of the radar echoes, for example, signs of life of vehicle occupants and thus their presence can be detected. The detection can be determined, for example, by the chest of the vehicle occupant rising and falling as a result of breathing. Depending on the vehicle, one or more UWB sensors may be provided for complete monitoring of the vehicle interior.

The raw data to be processed comprise a plurality of radar echoes of a radar pulse emitted repeatedly within a specified time interval as a function of a number of so-called taps. A tap represents a characteristic value for the range of the UWB sensor. The higher a so-called tap number, the greater the distance between the UWB sensor and the object reflecting the signal. The plurality of radar echoes is transferred to a higher-level computing unit after a respective filtering by a sensor computing unit, in order to be stored together in the higher-level computing unit as a radar image for further processing.

The storage as a radar image makes it possible to further process the images in the higher-level computing unit with the help of machine learning. For example, image evaluating approaches of machine learning can be used. However, this means that the higher-level computing unit has sufficiently powerful resources available for the processing.

### SUMMARY

In view of the foregoing, it would be advantageous to specify a method and a device which enable the processing of raw data from a UWB (radar) sensor with fewer resources.

A method for processing raw data of a UWB sensor is disclosed herein. The UWB sensor is an ultra-wideband radar sensor. It is arranged in a vehicle interior under the roof lining of the motor vehicle for monitoring the interior. The raw data comprise a plurality of radar echoes from a radar pulse emitted repeatedly within a specified time interval as a function of a number of taps. The taps represent a characteristic value for the range of the UWB sensor. After a respective filtering, the plurality of radar echoes are transferred to a computing unit in order to be stored together in the computing unit as a radar image for further processing. According to the disclosure, the number of taps is varied depending on an evaluation of a portion of the radar echoes.

The disclosed procedure allows the processing of the raw data with fewer resources of the (higher-level) computing unit. The further processing of the radar image in the computing unit using machine learning methods may further include the recording of the complete radar image and storage thereof in the computing unit before the evaluation by the machine learning algorithm takes place. For example, the evaluation can be carried out by a so-called convolutional layer of a convolutional neural network (CNN). Since the memory requirements for the radar image can be considerable and the resources of the memory in the computing unit are usually limited, it is useful to optimize them.

In order to optimize the memory requirement for the radar image required for the evaluation, according to the disclosure a variation of the number of taps is made depending on the situation and depending on the evaluation of a portion of the radar echoes. If, for example, no occupant could be detected in the monitored vehicle interior, for example on the seats of the motor vehicle that are further away from the UWB sensor (such as the rear seats in the case of a UWB sensor arranged in the front roof lining), this makes it possible to reduce the radar image to the areas relevant for evaluation. This approach is based on the assumption that UWB sensors require a relatively large amount of memory for the complete radar image, depending on the recording time and distance. This means that the greater the distance monitored by the UWB sensor, the greater the memory requirement for the radar image that must be stored for evaluation. Depending on an evaluation of a portion of the radar echoes, the number of taps is then varied in such a way that information at a greater distance from the UWB sensor is no longer taken into account in the radar image.

Conveniently, the number of taps is varied depending on an evaluation of the portion of the radar echoes received at the beginning of the specified time interval. In other words, the radar echoes received first (in terms of time) are evaluated in relation to information that has the greatest distance from the UWB sensor. Depending on the result of the evaluation of a portion of the radar echoes at the beginning of the specified time interval, a decision can then be made about varying the number of taps.

Another useful design provides that the evaluation of a portion of the radar echoes includes separate analysis of the dynamics for one or more selected taps. In particular, the evaluation includes separate analysis of the dynamics for one or more taps with a tap number greater than a specified value. The specified value can be specified once as part of a specification process that takes into account the location of the UWB sensor in the vehicle interior and the conditions of the vehicle interior in the motor vehicle. Alternatively, the specified value can also be set dynamically at the run time of the method based on the result of the analysis. In this configuration, the analysis of dynamics focuses on taps with a “high” tap number, which means that those areas that cover the greatest distance within the range that the UWB sensor can detect are taken into account. This makes it possible, for example, in the case of a UWB sensor located in the front area under the roof lining of the motor vehicle, to sense the area on the rear seat in order to determine whether there are children and/or animals there.

Appropriately, the evaluation will include whether an amplitude of the portion of the radar echoes for the taps with a tap number greater than a specified value is below a first predetermined amplitude limit. Alternatively or additionally, the evaluation includes whether an average value of the amplitude of the portion of the radar echoes for the taps with a tap number greater than the specified value is below a second specified amplitude limit. These two criteria can be used to determine whether or not there are vehicle occupants in the areas remote from the UWB sensor. If at least one of the two criteria is met, the taps with a tap number greater than the specified value are expediently not transferred to the computing unit. This can significantly reduce the memory requirement for the radar image that is stored in the computing unit. However, this reduction in the size of the radar image only occurs if the above criteria are met. If these criteria are not met, the radar image for each radar echo includes the total number of taps.

According to a second aspect, a computer program product is disclosed which comprises commands which, when the program is executed by a computing unit, cause it to carry out the method in accordance with one or more design variants.

According to another aspect, a device for processing raw data of a UWB sensor arranged in a vehicle interior under the roof lining of a motor vehicle is disclosed. The raw data include a plurality of radar echoes of a radar pulse emitted repeatedly within a specified time interval as a function of a number of taps that represent a characteristic value for the range of the UWB sensor. After a respective filtering, the plurality of radar echoes are transferred to a computing unit in order to be stored in the computing unit together as a radar image for the further processing. According to the disclosure, the UWB sensor is designed to vary the number of taps depending on an evaluation of a portion of the radar echoes.

In further configurations, the device is set up to carry out one or more embodiments of the method according to the disclosure.

### BRIEF DESCRIPTION OF THE DRAWINGS

The disclosure is explained in more detail below by means of an exemplary embodiment in the drawing. In the figures:

FIG. 1 shows a schematic representation of a device for processing raw data of a UWB sensor;

FIG. 2 shows a complete, unchanged radar image based on a plurality of radar echoes of a radar pulse emitted repeatedly within a specified time interval as a function of a number of taps; and

FIG. 3 shows the radar image shown in FIG. 2, the memory requirement of which is reduced by information reduction.

### DESCRIPTION

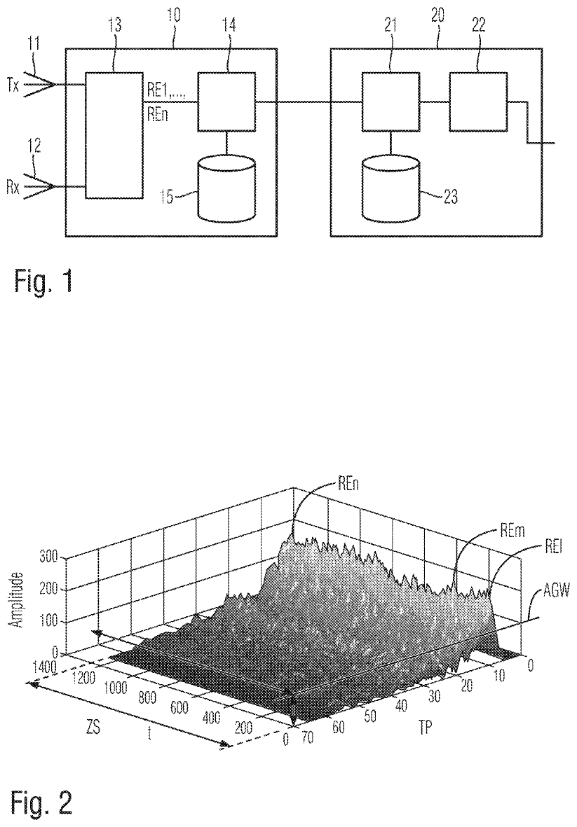

FIG. 1 shows a schematic representation of a device for processing raw data from a UWB sensor 10. The UWB sensor 10 contains two antennas 11, 12 in the known manner coupled to a transmitter/receiver unit 13. For example, the antenna 11 serves as a transmitting antenna (Tx) and the antenna 12 serves as a receiving antenna (Rx). The transmitting/receiving unit 13 is designed to repeatedly emit radar pulses via the antenna 11 within a specified time interval and to transfer the radar echoes RE1, . . . , REn received by the antenna 12 to a sensor processing unit 14 for processing. In order to carry out the processing steps it carries out, the sensor processing unit 14 is connected to a memory 15 in which data can be temporarily stored during processing. The radar echoes RE1, . . . , REn are caused by reflection of the radar pulses on static or moving objects. The suffix “n” stands for the nth received radar echo.

The UWB sensor 10 is arranged under the roof lining of a motor vehicle in a vehicle interior that is not illustrated in detail for monitoring the interior. For example, the UWB sensor 10 is arranged near the interior mirror under the roof lining and oriented in such a way that the radar pulses emitted by it are directed towards the front and rear seats. From the processing of the radar echoes RE1, . . . , REn reflected by the objects (static objects of the motor vehicle and/or motor vehicle occupants), the presence of occupants can then be concluded. For the processing, the plurality of radar echoes RE1 . . . , REn of radar pulses repeatedly emitted within the specified time interval ZS as a function of a number of taps TP are transferred to the sensor processing unit 14 of the UWB sensor 10 for pre-processing.

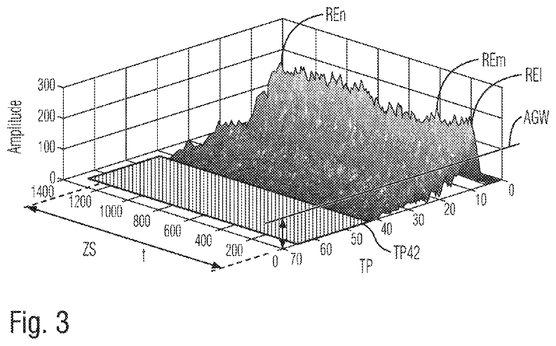

The radar image resulting from the pre-processing by the sensor processing unit 14, as shown for example in FIGS. 2 and 3, is then transferred to a control unit 20 for further processing. The control unit 20 can be a (central) evaluation control unit that receives corresponding radar images from a plurality of UWB sensors and, if necessary, other sensors.

The control unit 20 contains a computing unit 21, an image processing unit 22 and a data memory 23. It will be recognized that the computing unit 21 may be any of various computing units as will be recognized by those of ordinary skill in the art and may include both a processor and a memory. The computing unit 21 is used to receive the radar image as a data stream and to store it in the data memory 23 for further processing. The radar image is then fed to the image processing unit 22, wherein the image processing unit 22 can also have direct access to the data memory 23 for this purpose. The image processing unit 22, for example, contains a machine learning algorithm, in particular a neural network (Convolutional Neural Network, CNN), which is particularly suitable for evaluating images. As part of the evaluation, it is then determined whether there is an occupant in the vehicle interior or not. The type of image evaluation is not of central importance for the method described here, so that reference is made to the analysis possibilities known from the prior art.

FIG. 2 shows a complete radar image as it may be stored in the data memory 23 without further pre-processing in order to be fed to the image processing unit for further processing. The radar image covers a plurality of radar echoes RE1 . . . , REn, which were recorded consecutively within a specified time interval ZS from t=0 to t~1200. The amplitude curve against time or the radar echo REi (i=1 . . . n) is a function of a number of taps TP, wherein the taps are denoted by a number from z=0 to z=65. The larger the tap number TPz, the greater the distance of the object at which a radar pulse was reflected. The tap or tap number thus represents a characteristic value for the range of the UWB sensor 10 and indicates the distance up to which the UWB sensor 10 receives or can receive data. The further the UWB sensor 10 “looks”, i.e. the larger the tap number TPz, the more information has to be stored for a radar echo RE1 . . . , REn. The memory requirement for the radar image to be stored in the data memory 23 is measured depending on the number n of radar echoes and the tap number TPz.

The disclosure therefore provides for varying the tap number TPz depending on an evaluation of a portion of the radar echoes RE1 . . . , REm (with m<n), wherein the considered portion of the radar echoes RE1. REm is chosen at the beginning of the specified time interval ZS. For example, radar echoes within the time interval from t=0 to t=200 are chosen, wherein m corresponds to the m^{th} radar pulse at t=200.

For this portion of the radar echoes RE1, REm an analysis of the dynamics is performed for a portion of the taps TP. In particular, an analysis of the dynamics is carried out for taps with a tap number TPz that is greater than a specified value, for example 45. The specified value of the tap number TPz can optionally be specified once as part of a specification process that takes into account the type of UWB sensor, the location thereof in the vehicle interior and the size and/or volume of the vehicle interior. The specified value can also be set dynamically at the run time of the method based on the result of the analysis.

The evaluation includes whether an amplitude of the observed portion of the radar echoes RE1, REm for the taps with a tap number greater than the specified value, for example TPz=45, is below a specified amplitude limit AGW (see FIG. 2). In addition or alternatively, it can also be determined whether an average value of the amplitude A of the portion of the radar echoes RE1, . . . REm for the taps with a tap number TPz greater than the specified value is below a second specified amplitude limit.

If one or both criteria are met, then those taps TP with a tap number TPz greater than the specified value, in the example chosen here TPz≥45, will not be transferred to the computer unit 21. This is schematically shown in FIG. 3, in which the taps with tap number greater than TP 45 are illustrated with a hatched area, which are not taken into account further. This type of pre-processing takes place in the sensor computing unit 14. The memory 15 is used by the sensor computing unit to temporarily store the observed portion of the radar echoes RE1, . . . REm to determine whether or not the above criteria are met.

As explained above, if one or both of the criteria are met, only reduced data are transferred to the control unit 20 for the generation of the radar image by the computing unit 21 and are stored in the data memory 23 for the further processing by the image processing unit 22.

If, on the other hand, the criteria or one of the criteria are/is not met, this indicates that living organisms have been detected, for example, in the rear area of the vehicle interior. Therefore, in this case, all the information is transferred to the control unit 20 for the generation of the radar image according to FIG. 2.

The procedure described can be initialized, for example, if all doors have been closed in an exit scenario. In this scenario, it is then checked whether children and/or animals have been left behind in the vehicle. If the UWB radar sensor or the evaluation of the radar echoes detects that there is an amplitude in the second row of seats in the observed first radar echoes (also referred to as radar rounds), the full tap number for all radar echoes RE1, . . . REn is transferred to the control unit 20. If, on the other hand, the UWB sensor 10 does not sense an amplitude in the observed portion of the first radar echoes RE1, . . . REm in the second seat area, the tap number is reduced and the radar echoes are transferred to the control unit with a lower tap number.

Due to the reduced tap number, the need to store the entire radar image before transferring it to the image processing unit 22 is reduced. The unused storage space in the data memory 23 can then be used for other functions performed by the control unit. The smaller radar image also reduces the processing effort required for the further image processing.

### LIST OF REFERENCE SIGNS

10 UWB-Sensor
11 first antenna
12 second antenna
13 transmitter/receiver unit
14 sensor computing unit
15 memory
20 control unit
21 computing unit
22 image processing unit
23 data memory
RE1, . . . , REm, . . . , REn radar echo
ZS time interval
TP tap
TPz tap number with z=1.
AGW amplitude limit

1-10. (canceled)

11. A method for processing raw data from an Ultra Wide Band (UWB) sensor, the method comprising:
generating the raw data based on a plurality of radar echoes of a radar pulse emitted repeatedly within a specified time interval as a function of a number of taps representing a characteristic value for a range of the UWB sensor, wherein the UWB sensor is arranged in a vehicle interior under a roof lining of a motor vehicle for monitoring the interior; and
transferring the plurality of radar echoes to a computing unit after a respective filtering in order to be stored together in the computing unit as a radar image for further processing, wherein the number of taps is varied depending on an evaluation of a portion of the radar echoes.

12. The method as claimed in claim 11, wherein the number of taps is varied depending on an evaluation of the portion of the radar echoes received at a beginning of the specified time interval.

13. The method as claimed in claim 12, wherein the evaluation of the portion of the radar echoes includes a separate analysis of dynamics for one or more selected taps.

14. The method as claimed in claim 11, wherein the evaluation of the portion of the radar echoes includes a separate analysis of dynamics for one or more selected taps.

15. The method as claimed in claim 14, wherein the evaluation includes a separate analysis of the dynamics for one or more taps with a tap number greater than a specified value.

16. The method as claimed in claim 15, wherein the evaluation includes whether an amplitude of the portion of the radar echoes for the taps with a tap number greater than a specified value is below a first specified amplitude limit.

17. The method as claimed in claim 16, wherein the evaluation includes whether an average value of the amplitude of the portion of the radar echoes for the taps with a tap number greater than the specified value is below a second specified amplitude limit.

18. The method as claimed in claim 15, wherein the evaluation includes whether an average value of an amplitude of the portion of the radar echoes for the taps with a tap number greater than the specified value is below a second specified amplitude limit.

19. The method as claimed in claim 18, wherein the taps with a tap number greater than the specified value are not transferred to the computing unit.

20. The method as claimed in claim 17, wherein the taps with a tap number greater than the specified value are not transferred to the computing unit.

21. A non-transitory computer program product comprising commands which, when the program is executed by a computing unit, cause it to carry out the method according to claim 11.

22. A device for processing raw data in a vehicle, the device comprising:
an ultra-wide band (UWB) sensor arranged in a vehicle interior under a roof lining of a motor vehicle for monitoring the interior, wherein the raw data comprise a plurality of radar echoes of a radar pulse emitted repeatedly within a specified time interval as a function of a number of taps representing a characteristic value for a range of the UWB sensor, wherein the UWB sensor is designed to vary the number of taps depending on an evaluation of a portion of the radar echoes; and
a computing unit configured to receive the plurality of radar echoes, wherein the plurality of radar echoes are transferred to the computing unit after a respective filtering in order to be stored together in the computing unit as a radar image for further processing.

23. The device of claim 22, wherein the number of taps is varied depending on an evaluation of the portion of the radar echoes received at a beginning of the specified time interval.

24. The device of claim 23, wherein the evaluation of the portion of the radar echoes includes a separate analysis of dynamics for one or more selected taps.

25. The device as claimed in claim 24, wherein the evaluation includes a separate analysis of dynamics for one or more taps with a tap number greater than a specified value.

26. The device as claimed in claim 25, wherein the evaluation includes whether an amplitude of the portion of the radar echoes for the taps with a tap number greater than a specified value is below a first specified amplitude limit.

27. The device of claim 26, wherein the evaluation includes whether an average value of the amplitude of the portion of the radar echoes for the taps with a tap number greater than the specified value is below a second specified amplitude limit.

28. The device of claim 27, characterized in that the taps with a tap number greater than the specified value are not transferred to the computing unit.
